(19) United States
(12) Patent Application Publication
(10) Pub. No.: US 2023/0238918 A1
(43) Pub. Date: Jul. 27, 2023

(54) METHOD FOR DETECTING PV ANOMALY AND DETERMINING LONG-TERM DEGRADATION

(71) Applicant: LABORELEC CVBA, Linkebeek (BE)

(72) Inventors: Arnaud LAMBERT, Kwalm (BE); Quentin VAN NIEUWENHOVEN, Linkebeek (BE); Stijn SCHEERLINCK, Linkebeek (BE); Emmanuelle BERTRAND, Linkebeek (BE); Bertrand HAUT, Linkebeek (BE); Simon-Pierre CORDONNIER, Linkebeek (BE); Andreas WABBES, Linkebeek (BE)

(21) Appl. No.: 18/002,182

(22) PCT Filed: Jun. 18, 2021
(86) PCT No.: PCT/EP2021/066677

§ 371 Date: Dec. 16, 2022

(30) Foreign Application Priority Data
Jun. 18, 2020 (BE) BE2020/5445

(51) Int. Cl. H02S 50/10

(52) U.S. Cl. CPC H02S 50/10

(57) ABSTRACT

The invention contributes to combat climate change by enabling the operation of a photovoltaic (PV) plant at high performance by providing based on the typically available metering a more or less topology agnostic automated set-up. Additional information can also be used such as sun positions and/or being designed for nominal powers. The invention relates to a method for determining performance deviation of a PV configuration, only taking electrical measurements into account thus excluding irradiance data. In addition, a method is provided for detecting underperformance within a PV plant with high accuracy. The invention also relates to a method for determining long-term degradation of a PV installation.

### TECHNICAL FIELD

The invention relates to a method for detecting underperformance within a photovoltaic (PV) plant with high accuracy and only taking electrical measurements into account, i.e. excluding irradiance data from for instance weather stations. The invention also relates to a method for determining performance deviation of a PV configuration, to be used as basis for the underperformance detection. In addition, the invention relates to a method for determining long-term degradation of a PV installation. The invention further covers computerization of the methods as well as a PV plant making use of or being adapted to support execution of any of the methods.

### BACKGROUND OF THE INVENTION

To combat climate change technical installations relying on renewable energy such as photovoltaic (PV) installations are of key importance. However, due to this key importance, the effectiveness of their use depends substantially on their real performance, especially in case of large-scale photovoltaic installations, also known as PV plants.

As such PV plants in essence comprise of a large amount of modules, connected in accordance with a certain topology, the effectiveness question raised above, technically translates to a real (long-term) performance monitoring of these modules and associated power electronics for processing the electric power produced.

Theoretically speaking performance is defined as the amount of electricity delivered given a certain irradiance of the sun. As the sun or solar irradiance is varying, proper determination of the performance hence requires measuring the irradiance in combination with metering the amount of electricity produced by the PV plant. In reality however, irradiance measurements are difficult to perform and expensive, and therefore not available at all PV plants. When available, uncertainty in the measurements arises due to instrument accuracy, lack of maintenance (soiling, calibration issue...) and difference in the solar spectrum measured by the instrument and the one captured by the PV cells. On large PV sites, spatial difference in irradiance due to clouds can also occur.

On the other hand, large-scale photovoltaic installations do have electricity metering capabilities but note that these are there to monitor the electricity produced and not for performance determinations per se. Hence, they are also sparsely available throughout the installation (often linked to power electronic systems in place). Moreover, multiple modules within the PV plant can be connected in accordance with a variety of topologies, making the metering output relationship with performance topology dependent. The measured electricity produced thus corresponds to a large set of modules. For this reason, anomalies affecting only a small part of the installation are difficult to observe.

In order to detect performance deviation, analysts use a variety of tools to compare current performance with historical data or with a model estimating the expected performance. Identifying optimal tools is not an easy task, considering the myriad factors that must be carefully evaluated in order to accurately assess PV plant performance. Communications failure, sensor miscalibrations, excessive soiling, or even cloud cover, can alter the accuracy of the chosen benchmarks, making them irrelevant.

Anomaly detection tools based on historical data or a physical model of the PV plant will always be impacted by the irradiance measurement: uncertainty associated to the measurement as described above is generating a lot of noise and preventing the detection of small underperformances.

Besides operational issues affecting the plant at specific moments in time (strings disconnection, shading, soiling...), another problematic in PV plant performance is the premature ageing of modules. The estimation of the so-called long-term degradation is being studied by a lot of stakeholders in PV world. Evaluation of this degradation is often compromised by other anomalies impacting the plant and causing punctual underperformances.

The operations and maintenance (O&M) of solar PV plants is changing to become both more professional and more effective. The essential role of quality O&M services in ensuring the long-term, sustainable performance of solar PV assets is now being recognized. Data analytics is one of the means to support plant operators for effective O&M.

### Aim of the Invention

The aim of the invention is to provide a solution for determining performance of a PV plant, and in particular the deviation thereof, excluding the need or use of irradiance data. Herewith, the aim is also to define a performance reference or threshold, such that a measure for underperformance can be given. The invention also aims to provide a solution for determining long-term degradation of a PV installation. Both the measure of underperformance resulting from plant anomalies and the estimation of the long-term degradation contribute to give the plant operator a global health status of the PV plant also indicating, for what concerns anomalies, which part of the installation is concerned.

### SUMMARY OF THE INVENTION

The invention provides methods for determining or detecting performance deviation, such as for example more suddenly occurring anomalies or faults of a PV configuration. The PV configuration comprises of an amount, possibly unknown amount, of modules of a PV plant, being connected. The modules are for example serially connected in strings, which in turn are connected in parallel to DC combiner boxes, being finally connected to an inverter. The PV configuration in these methods relates to a so-called combining system and all the components below it for which electrical data monitoring is available (e.g. at string level or at inverter level). The invention also provides methods for determining or detecting degradation of a PV configuration, such for example long-term degradation as caused by ageing. Both the performance deviation and the degradation together may define a (global) health status of the PV configuration. Determining or detecting performance deviation or degradation of the PV configuration is accomplished from data being representative for the power generation, from a plurality of PV configurations, being for example substantially similar, without or excluding the use of irradiance measurements which means that such irradiance measurements are at least not required.

The methods in accordance with the invention are to be used for example for regular south-oriented large-scale PV plants on flat terrains, large-scale PV plants on wavy terrains, large-scale PV plants in shadowed conditions (next to or in mountains), east-west-oriented large-scale PV plants, large-scale PV plants with 1-axis trackers, large-scale PV plants with 2-axis trackers, rooftop installations (flat and inclined), vertical installations (including façades), floating PV installations, agri-photovoltaic installations, and possibly small residential installation, including fleets thereof.

According to an embodiment, the data used for determining or detecting performance deviation or degradation of the PV configuration, and being representative for the power generation is electrical data, such as for example power, but also current and voltage are possible and could be applied for a better fault diagnosis. According to an embodiment, other (non-electric) inverter measurement data such as inverter alarms, and inverter temperature, could also be used. Again, these could be applied for a better fault diagnosis. According to an embodiment, the sun position is used, or e.g. hour of the day, time in the year and maybe horizon line, terrain topology (to account for shading, e.g. a model can be built to predict power in function of external parameters and output can be used in normalization). According to an embodiment, nominal power of inverters is used but also any other static information about the PV plant (like module/inverter efficiency, number of strings...). This could be used to improve normalization. According to an embodiment, available monitoring data related to tracking in PV plants with tracker is used (e.g. tracker and actuator current, or actual position of each actuator in order to detect tracker default or underperformance).

In a first aspect of the invention a method is provided for determining performance deviation of a PV configuration from data, representative for the power generation, from a plurality of PV configurations (of which the PV configuration is part) without the use of irradiance measurements. According to an embodiment, the PV configurations can be considered substantially similar. The method comprising the following steps. In an initial step, the data being representative for the power generation, and originating from the plurality of PV configurations, is provided or loaded. Next, the data is normalized in order to obtain normalized power generation data for comparing amongst the plurality of PV configurations. Although PV configurations can be considered substantially similar, normalization is performed to correct for small differences. And then, the performance deviation of the PV configuration is determined from the normalized power generation data by comparison amongst the plurality of PV configurations.

The data being normalized may comprise of firstly, determining first normalization information from the loaded data, and secondly, normalizing the data by use of first normalization information. Moreover, determining first normalization information may comprise determining a relationship, possibly linear (e.g. a hyperplane) between the data. Moreover, the step of determining first normalization information may comprise determining a relationship between the data, representative for the power generation, from a plurality of PV configurations; and preferably prior to first normalization information being determined, the data, representative for the power generation, is for each of said PV configuration being divided by its average or median value or nominal value. In determining a relationship, this may be based on (quantile) regression, or this may be performed pair-wise between inverters. Next to pair-wise quantile regression, quantile regression of each inverter compared to a normalization reference computed statistically from all the inverters, can also be performed. According to an embodiment, the step of determining a relationship being performed either (a) for each inventor relative to a normalization reference, preferably the normalization reference being computed from power generation data from the plurality of PV configurations, or (b) pair-wise between inverters, wherein preferably prior to the determining a relationship a (data cloud) clustering is performed, relationships per cloud are determined and said relationship is selected therefrom. It is further mentioned that normalization can be done using a shading model (although rather as a side effect), meaning that normalization is executed because of the fact for instance that the PV installation or panels in particular are located in the mountains and hence are subject to shading.

The method may further comprise, in particular when the data being normalized, providing or loading of nominal power of the plurality of PV configurations, and using this nominal power for determining second normalization information. Further, using this nominal power may comprise of retrieving the first normalization information as determined and correcting this first normalization information to obtain corrected first normalization data, herewith determining the second normalization information, which can be used in further post-processing.

In an embodiment, the step of determining the performance deviation of the PV configuration comprises the step of computing a (relative) metric of performance of the PV configuration, in relation to the performance deviation being determined, relative to a (computed) performance reference (which may differ from said normalization reference), preferably said reference being computed from said normalized power generation data, preferably after said second normalization, from the plurality of PV configurations.

The method may further provide or load information related to the sun position, either direct or indirectly such as PV plant position from which sun position can be calculated. This sun position information can then be taken into account (e.g. by taking into account shading effects) for determining the performance deviation of the PV configuration or can be used in further post-processing.

Prior to normalizing data, a pre-processing step may be applied onto the loaded data. The pre-processing step may perform one or more of the following: selecting of non-zero data amongst said data e.g. to remove unavailability, filtering outliers e.g. by use of, for example but not limited thereto, a histogram method, a median absolute deviation method or z-score and/or selecting of (non-zero) (filtered for outliers) data exceeding a predetermined threshold.

In a second aspect of the invention a method is provided for detecting underperformance of a PV configuration from data, representative for the power generation, from a plurality of PV configurations (of which the PV configuration is part) without the use of irradiance measurements. With underperformance is not necessarily meant electrical underperformance. For example, mechanical underperformance (e.g. due to misorientation of the PV panels) is also understood and to be covered by underperformance. The PV configuration may comprise of an (unknown) amount of modules, e.g. being serially connected in strings, those being connected in parallel to DC combiner boxes finally connected to an inverter. The PV configuration used in this method relates to the ‘combining system’ and all the components below it for which electrical data monitoring is available (e.g. at string level or at inverter level). In an embodiment, the PV configurations are considered substantially similar. The method for detecting underperformance comprises the steps of the method for determining performance deviation in accordance with first aspect of the invention, wherein the step of determining the performance deviation of the PV configuration comprises the step of computing a (relative) metric of performance of the PV configuration, in relation to the performance deviation being determined, relative to a (computed) performance reference configuration. The method for detecting underperformance further comprises an additional step of comparing the (relative) metric of performance of the PV configuration with a threshold, by means of which said underperformance is detected. By means of detecting underperformance is subsequently determined which one of the PV configurations is underperforming as well as the location thereof.

Prior to the additional step of comparing, the (relative) metric of performance of the PV configuration may be filtered e.g. as a post-processing step, for smoothening purposes.

In a third aspect of the invention a method is provided for determining long-term degradation of a PV configuration from data, representative for the power generation of the PV configuration without the use of irradiance measurements. The method comprises the steps of firstly, providing or loading data, and secondly, determining the long-term degradation of the PV configuration from determining a long-term trend therein.

The step of determining the long-term degradation may be based on (quantile) regression. For example, q-quantile linear regression can be applied, but also other types of linear regression, as well as non-linear regression could be used. Although methods of degradation (performance loss rate) are also part of the invention, the invention rather focuses on the filtering of the underperformance prior to degradation estimation whatever the method used afterwards. Other methods such as Year on Year can be used. In Year on Year, the differences between one data-point in a calendar year with the data-point at the same position in the subsequent year are accumulated over a 1-year period. The median value of these multiple yearly performance loss rates represents the overall system performance loss rate.

Prior to determining the long-term degradation, a first pre-processing step may be applied onto the loaded data. The first pre-processing step may perform a selecting of the data related to sunny production months. Prior to determining the long-term degradation, a second pre-processing step may be applied onto the loaded data. The second pre-processing step may perform a selecting of said data exceeding a predetermined threshold. Prior to determining the long-term degradation, a third pre-processing step may be applied onto the loaded data. The third pre-processing step may perform an outlier filtering. Prior to determining the long-term degradation, a fourth pre-processing step may be applied onto the loaded data. The fourth pre-processing step may perform a (mean) aggregation over a predetermined period.

Prior to applying any of the first, second or third pre-processing step, an initial filtering may be performed, based on (short-term) underperformance as determined by the method in accordance with second aspect of the invention.

In a fourth aspect of the invention computerization of any of the above methods is provided. More in particular, a computer program product is provided comprising computer-readable code, that when run on a computer environment supports execution of any of the methods in accordance with first, second or third aspect of the invention. Further, a database is provided, adapted to run on a computer environment, comprising data from a plurality of (substantially similar) PV configurations and suitably arranged for use by any of the methods in accordance with first, second or third aspect of the invention. It is noted that data may be received from plant operator, wherein such data being put in the good format for execution of the code.

In a fifth aspect of the invention a PV plant is provided, comprising of a plurality of PV configurations that possibly are to be considered substantially similar. The PV plant further comprises a plurality of power generation measurement equipment, one for each PV configuration, and also comprises a computer environment, connected to the plurality of power generation measurement equipment and adapted to or enabling support execution of any of the methods in accordance with first, second or third aspect of the invention.

### BRIEF DESCRIPTION OF THE DRAWINGS

FIG. 1 illustrates an embodiment of the method for determining performance deviation applied to a PV plant in accordance with the invention.

FIG. 2 illustrates a further version of the embodiment of FIG. 1 regarding the method for determining performance deviation applied to a PV plant in accordance with the invention.

FIG. 3 illustrates an embodiment of the method for detecting underperformance applied to a PV plant in accordance with the invention.

FIG. 4 illustrates an embodiment of a PV plant of a first topology for which execution of any of the PV anomaly detection methods in accordance with the invention is applicable.

FIG. 5 illustrates an embodiment of the method for determining long-term degradation applied to a PV plant in accordance with the invention.

FIG. 6 illustrates an embodiment of a PV plant of a second topology for which execution of any of the PV anomaly methods in accordance with the invention is applicable.

FIG. 7 illustrates an example of graph per inverter for the long-term degradation determination in accordance with an embodiment of the invention.

FIG. 8 illustrates an example of quantile regression between inverters in accordance with an embodiment of the invention.

FIG. 9 illustrates an example of underperformance graph per inverter in accordance with an embodiment of the invention.

FIG. 10 illustrates another example of underperformance graph per inverter in accordance with an embodiment of the invention.

FIG. 11 illustrates another example of quantile regression between inverters in accordance with an embodiment of the invention.

### DETAILED DESCRIPTION OF THE INVENTION

The invention relates to determining performance deviations (which can be used as part of detecting underperformance (via comparing a metric with a threshold)).

The invention further relates to determining long-term degradation (via determining a long-term trend).

The notion of performance deviations is used for anomalies related to operation issues and hence punctual or sudden underperformances, while the term long-term degradation, also denoted continuous degradation, relates more to aspects like premature ageing. Both define together the global health status. For the sake of clarity, performance may be related to both electrical and mechanical performance (issues).

It is worth emphasizing that the invention recognizes that these are separate concerns, which can nevertheless be determined from specifically selected parts of the same data set, moreover that one concern (the underperformance) might compromise the evaluation of the degradation and hence correction via the performance method before executing the long-term degradation method is recommendable.

Before going to the details of one or more (preferred) embodiments, it must be emphasized that the technical challenge is to provide methods with high accuracy. As will be mentioned, use of irradiance data (though prima facie or theoretically in relation to a PV plant performance a good candidate to compute performance) is typically a source of trouble (in terms of difficulty to perform, lack of instrument accuracy (which may be on its own 3% inaccurate), and lack of maintenance, in part also in relation to issues that may cause the plant underperformance like soiling, hence the invention aims at the use of electrical measurements only, hence without use of irradiance data. It is the contribution of the invented methods – contrary to the prior-art, based on comparing present performance with historical data, which, for a variety of reasons indicated in the application, prove to provide the wrong benchmark – that the data set captured on the plant under study and solely said dataset alone (e.g. in order to normalize but also even in relation to defining suitable thresholds as being elaborated on further), provide accuracies, indicating performance losses as low as 2%.

While the invention used as basic steps standard features such as regression, pre-processing as such are standard features, be it in a particular order or sequence, it is worth noting that operating on the data set captured on the plant under study and solely said dataset alone, requires special technical considerations, as indeed such data sets are often unclean (unavailable, wrong values, non-representative) for the purpose given and hence clean-up operations are required, which may as such also be considered standard but the impact of those clean-up operations should not jeopardise the ultimate purpose, hence effects of over- or underweighting inverters is taken into account.

It is worth describing normalisation from calibrating and/or correcting data from sensors. Contrary to that, the invention, in its urge to do the performance deviation determining, without additional measurements like irradiance measurements, hence solely on data, representative for the power generation, puts forward the notion of normalisation, by use of normalisation information based on a relationship between data from the plurality of PV configurations involved, in a more particular embodiment this is done pair-wise between inverters or relative to a performance reference computer from said inverters. In the invention we use the data of the different inverters or other subsystems (that could be combiners (monitoring data associated to a plurality of PV strings)) to normalize and therefore take into account difference in design that may exist between these subsystems, before we compute a metric and then do a comparing step. It is the contribution of the invention to realize that with proper normalisation (as explained above) and other data manipulations this can be done while retaining high accuracy (as indicated above).

The technical problem solved by the present invention is the determination of PV plant performance while not relying on or needing irradiance measurements. With the invention is determined, a suitable performance reference to assess performance of individual PV configurations relative to such performance reference. A PV configuration comprises of an (unknown) amount of modules being connected. Underperformance detection can be performed with high accuracy, i.e. with less than 2% performance loss. The invention further covers the localisation of any performance issues through the identification of bad performing modules or PV configurations.

The technical solution of the present invention is based on use of the metering information, installed in the PV plants (be it for other reasons) and the insight that suitable PV plant performance and references can be determined again while not relying on or needing irradiance measurements if proper normalization and other data manipulations such as pre- and post-filtering are performed. The metering information delivers data, representative for the power generation and being for example AC/DC measured power, voltage or current. It is worth emphasizing at this stage that these manipulations are based on insight in the dynamics of the PV plant including sun interaction (e.g. selecting time periods, or filtering low power data corresponding to low irradiance (low irradiance data bringing noise in the evaluation)), the intrinsic quality of the metering information (e.g. the role of errors and the requirements to discard those in a proper way but also the roughness of the data set). Also, the possibility to implicitly take into account the topology issues by use of nominal (designed) performance is to be emphasized. Differences in performance of the PV configurations related to design (different nominal power, shading...) are taken into account thanks to the normalization process. As explained, nominal power is not directly required to run the algorithm but can be used to derive the relative performance of the inverters corrected by this nominal power (removing thus the difference related to different nominal power and allowing to see differences among inverters only due to terrain topology or other specific site constraints).

Besides underperformances that occur suddenly in a PV plant, another concern in effective use of the PV plant is the long-term continuous degradation. It is an aspect of the invention to be able from in essence the same data set as used for determining the PV plant performance to properly separate these two concerns, determine the proper conclusions and even to correct in one another for these effects.

The amount of available information, depending on the level of monitoring, can be quite important. E.g. considering one inverter collects current from 100 strings, if data is available at string level, there is 100 times more data than if monitoring at inverter level only. Hence, the technical problem translates into obtaining this data (loading), storing (a proper subset e.g. aggregate data to hourly values if available each second) in a proper arrangement (database) and in setting up the above performance deviation determination and/or underperformance detection (in case a threshold is defined) including the field knowledge outlined above.

In summary we can state that the invention contributes to combat climate change by enabling the operation of a PV plant at high performance by providing based on the typically available metering a more or less topology agnostic automated set-up whatever the difference in nominal powers of e.g. inverters, however capable to use also additional information such as sun positions.

The invention leverages on the insight that the PV plants in essence comprise of a repetition of substantially similar PV configurations i.e. modules being connected in a certain topology to a connection or combination point like the corresponding inverters, and hence translations to use of the available metering at these connection or combination points. The available metering monitors the production generated by the PV configuration it relates to (e.g. in case of monitoring at an inverter output, the measured production relates to all the modules connected to this inverter including efficiency of all electrical components (combiner boxes, cabling...) as well as efficiency of this inverter). According to an embodiment of the invention, the power from multiple PV configurations, or in particular the inverters thereof is normalized. As yet referred to for PV configurations, inverters can be considered substantially similar, however normalization is performed to correct for small differences. The multiple inverters, to be interpreted as subsystems (and part of a PV configuration) of a PV plant, are now comparable and a deviation in power of one inverter compared to others (a performance reference is computed based on all inverters) indicates an anomaly. It is noted again that, according to a variation of this embodiment, equivalent interpretation can be made for the PV configuration replacing the inverter in the wording herewith. The comparison of inverters or subsystems in general (or PV configurations even more general) is done by means of an algorithm in accordance with the invention. It may further include pre-/post-treatment of noise-filtering or noise reduction, or advanced filtering, and/or using statistics such as for example correlation techniques. For the PV plants considered, the inverters or subsystems are usually substantially similar, meaning that most of the time they have more or less the same design (e.g. orientation, slope, technology), they are mounted more or less the same way (e.g. same angle), and they experience the same environment (e.g. in terms of irradiance or temperature). Hence, the inverters or subsystems (or PV configurations), after normalization to account for still existing design differences, are directly comparable. Moreover, the degree of comparability is related to the level of accuracy of detection that can be obtained. In other words, referring to PV plant configurations or subsystems being substantially similar will result in very high accuracy achieved for the underperformance detection using the methods in accordance with the invention.

The invention hence provides a method for determining performance deviation of a PV configuration from data, representative for the power generation, and a method for detecting underperformance of a PV configuration making use of the former method. The invention further provides a method for determining long-term degradation of a PV configuration, wherein such method may use the method for determining performance deviation of a PV configuration as an initial or further filter.

Next to high accuracy which can be achieved with the underperformance detection, the invention provides also other benefits. While referring again to determining performance deviation, due to the fact that the data used from the metering information is particularly representative for the power generation, mainly so-called power data is used and hence the requirements on data use are rather low. Considering this and for example the fact that PV plant configurations or subsystems being substantially similar, the methods in accordance with the invention deliver fast data loading and pre-treatment and execution of results for evaluating the PV plant performance. Further, while applying these methods, no additional hardware is needed as only existing infrastructure is being used. Hence, the invention represents a rather cost-efficient solution, the more because there are not really heavy calculations or computations involved. Moreover, the methods can be applied independently of other existing monitoring platforms or systems being present.

As yet mentioned, PV plants most of the time consist of a repetition of similar configurations (e.g. modules connected in strings to an inverter). The production of these inverters (after normalization) can be compared as these systems are subject to the same environmental conditions. The methodology used in accordance with the invention, has been developed based on this statement. According to an embodiment, a comparison is made between all inverters, after application of a set of filters and normalization, and identification is done whenever a signal is differentiating from the others which corresponds in theory to an underperformance of the corresponding inverter. Herewith defined fault detection algorithm being based on the comparison of inverters, will be inherently less applicable to small plants with limited number of similar inverters with appropriate monitoring. However, it can be applied also to other levels of monitoring such as strings and array boxes if available. It is noted again that, according to a variation of the embodiment, equivalent or similar interpretation can be made for the PV configuration, replacing the inverter in the wording above therewith.

Regarding the premature ageing of modules, also being part of PV plant performance problems, another fault detection algorithm is presented in accordance with the invention. This phenomenon cannot be detected with the comparison of inverters as it normally affects them in the same way. A method was developed to evaluate the long-term degradation of PV modules excluding the irradiance measurement and using the detected underperformances as input.

The two methods or algorithms, i.e. respective fault detection as further referred to “inverters underperformance” and “long-term degradation” estimation, constitute a performance quick scan tool in accordance with the invention. With performance quick scan tool is meant that the performance, or underperformance in particular, and/or long-term degradation are detected and visually represented in a rather rapid and simple way, by means of using data that are already present and stored in the PV environment concerned. According to an embodiment, the constitution of the PV plant performance quick scan tool is based on implementation choices (e.g. filtering, statistical evaluation), parameter choices, and description of models. The tool is independent of any monitoring system and is not demanding in data types (only power of the different inverters) limiting the possible issues related to data quality and required pre-treatment. No configuration is required although knowing nominal DC power connected to the inverters allows additional evaluation to be provided to the user but algorithms can run without this information. These characteristics together with the fact the algorithms are automated, make the quick scan tool appropriate to evaluate the health status of a complete fleet of PV plants. Besides operators, the tool can also be of interest for investors by providing extra functionalities such as translating the performance deviation in production loss or ranking the plants of a fleet according to their performance.

### A. Algorithm Exemplary Embodiments

In an embodiment, the inverters’ underperformance is detected. The purpose of the detection method or algorithm “inverters underperformance” is to detect underperformance by comparing all inverters after normalization of their performance (due to differences in the number of modules, design configuration, etc.). If one inverter deviates from others (lower production than other inverters), this inverter underperforms compared to other inverters. In order to reduce noise, very temporary underperformance issues are filtered. An underperformance (or missing data) of an inverter during a few e.g. 10 minutes is not considered of importance. Underperformance of a duration of one week is for example targeted with this algorithm. This method allows to avoid the use of irradiance as its inaccuracy (approximately 3%) can impact the detectability of underperformances.

In an embodiment, the inverters’ long-term degradation is determined. The purpose of the algorithm “long-term degradation” is to catch the degradation of module performance over the years by selecting each year the highest productions of each inverter. The highest productions selected statistically should a priori correspond to periods of high irradiance (clear sky days). It is known that conditions will vary from year to year (e.g. ambient temperature, extreme climatic conditions) but it is expected that the averaging over long period (more data) will limit the impact of these external factors. Long-term degradation is for instance defined as the rate of production decrease of an inverter over the years. A minimum of e.g. 2-3 years is required for long-term degradation evaluation.

Referring to the embodiments above, the data required as input to the algorithms comprises the different timestamps. Time resolution should be for example at least 1 measure per hour. The data further comprises the power of each inverter (it can be AC or DC) at the corresponding timestamp.

### B. Filter

In an embodiment, a phase of pre-filtering is defined in order to keep only non-zero data, to filter the outliers and to keep only significant production over the months.

If there are some timestamps with small values near to zero but not equal to zero (due to imprecision of sensors as example), these values are cached to zero. By default, the lower parameter, the limit value to determine if lower values than lower parameter are small values near to zero, is equal to zero.

This first “keep only non-zero data” filter can be quite simple, by retaining only productions for all inverters strictly larger than zero. In other words, if one inverter is showing a zero value and the others not, the point is not filtered.

In addition, a filter may detect in the dataset when production data is fixed. For example, is checked in the dataset if there are more than 5 production data with the same value following. And if so, it removes these production data from the dataset.

Over the productions data, the outliers can be filtered by histogram methods. Here, by means of example, a histogram method generates bins with production values. The step is to “bin” the range of values, it divides the entire range of values into a series of intervals. Then it counts how many values fall into each interval. It defines for instance a cut such that the cut is the first bin among the bins with zero production data inside. The filter keeps only production values for every b in all bins such that b < cut.

By means of a heat map, the unavailability of inverters can be displayed. The unavailability is e.g. defined as the ratio between the number of elements with no production and the total number of elements over a window. It allows to display periods with unavailability of inverters in comparison with other inverters of the park. By default, the window is for example one month. Different colours in the heap map may represent different percentage ranges of unavailability, e.g. less than 5%, between 5% and 10%, between 10% and 20%, more than 20%.

In order to retain only significant production over the months, a timestamp can be retained if at least one inverter is producing something significant. Significant is e.g. defined here as a given percentile of all productions associated to the same month. In other words, for each month (from January to December), the percentile 75 of productions is for example computed. Only significant production is retained, e.g. meaning when at least one of the inverters produces more than the percentile 75 of the month.

### C. Identification of Linear Shift Between Inverters

In an embodiment, the production of two inverters from a PV plant are considered: inv_1 and inv_2. The linear shift between inv_1 and inv_2 is e.g. defined as the slope coefficient of the linear relation between inv_1 and inv_2 productions taking all historical data into account. A matrix of slope coefficients across all the inverters is used to normalize inverters’ production before identifying performance deviations (see paragraph below, regarding relative error with reference).

Differences between inverters may come from the fact that some not necessarily have the same installed power leading to different productions. If one corrects for this nominal power, the remaining differences can be due to design, e.g. structural shading on one inverter. The matrix (corrected for nominal power) provides valuable information to understand which inverters of the PV plant are the best, respectively worst, performers.

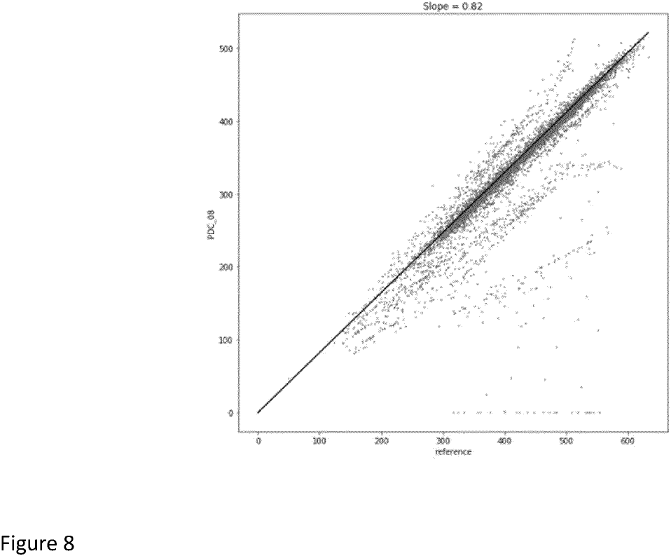

In order to compute the linear relation between inv_1 and inv_2, a quantile regression (estimating the conditional median (or other quantiles) of the response variable) between inverters’ production inv_1 and inv_2 can be fitted. Quantile regression is for instance chosen for, whereas the estimates can be considered more robust against outliers in the response measurements, including such regression may be advantageous when conditional quantile functions are of interest. FIG. 8 illustrates an example of quantile regression between inverters in accordance with an embodiment of the invention. Next to pair-wise quantile regression, quantile regression of each inverter compared to a normalization reference computed statistically from all the inverters (e.g. percentile 90 (or P90) of inverters power data), can also be performed. Regarding the normalization reference, a first step may be to divide each inverter power by its median. This step could be added in the pre-processing steps. When several clouds of points appear in the scatter plot (due to different historical operation modes), a filter can be applied to eliminate the lowest data points and capture the linear regression of the highest cloud of points.

It is further mentioned that normalization can be done using a shading model (although rather as a side effect), meaning that normalization is executed because of the fact for instance that the PV installation or panels in particular are located in the mountains and hence are subject to shading.

Considering again the matrix containing all linear shifts in order to detect underperformance of inverters. The nominal powers of inverters are possibly not the same on a park or PV plant. So, the linear shift can be simply due to the different nominal powers. This can be due to plant design. Presented solution is to create a further matrix that takes into account the nominal powers of inverters. The further matrix thus contains all linear shifts to detect underperformance of inverters, corrected by their nominal power.

According to an embodiment applying a different normalisation method than is referred to above, we first divide all power data by their median (could be the nominal power if available) and then we determine the linear shifts. Thus the nominal power (or median if not available) is already taken into account and we do not need to describe the step here anymore.

### D. Underperformance Computation

According to an embodiment, relative errors with performance reference are used for comparing the underperformance of an inverter with other (reference) inverters. The purpose of the relative error with performance reference is to display the underperformance of inverters compared to others. The points are treated as provided in the dataset. A particular quantile, for example 0.8 of all inverters’ production is e.g. defined as the performance reference for all timestamps. For each inverter, the relative error, i.e. the difference between its production and the performance reference divided by this reference, is thus computed. A local regression (sliding median) can also be computed over the timestamps. It will allow to smoothen the errors between inverters’ production and the reference production.

In a preferred embodiment the percentile chosen for normalization reference and performance reference is different in that:
for the normalization reference, the objective is to catch mainly differences between inverters related to design so we look at high productions; while
for the performance reference, it might be tempting to also increase the reference to a higher percentile (e.g. P95) to catch the best performing inverters but as the risk of selecting abnormal values becomes too high and hence P80 can be used with a clear understanding of the results.

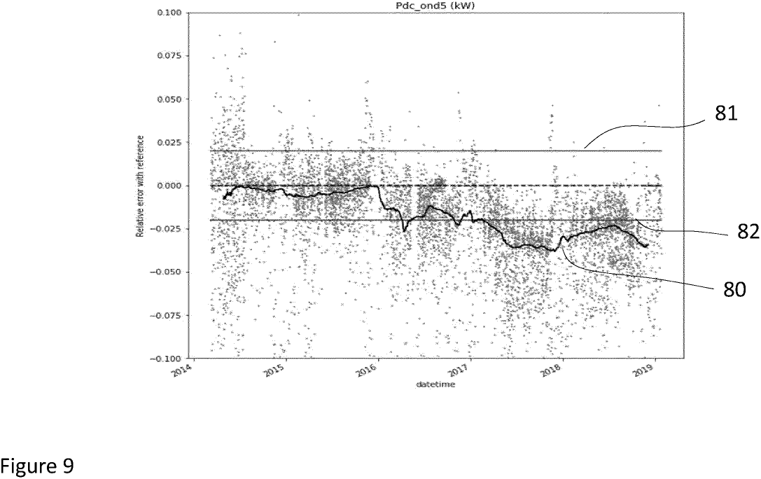

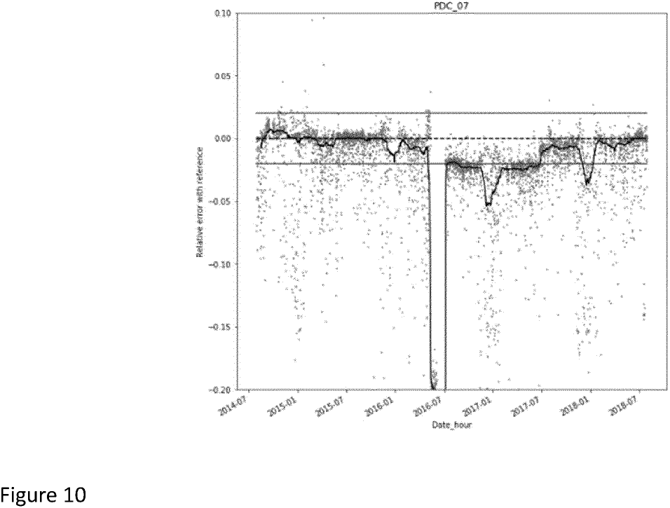

A graph of the relative errors between the inverter production and the performance reference can be generated. All the errors and the smoothened errors, i.e. sliding median, can be displayed on a timeseries plot. If the smoothened error is below a certain threshold (e.g. -2%), it means that the inverter underperforms compared to other (reference) inverters. In order to avoid side effects, the sliding median is for example not applied on half of the windows at start and end of the timestamps. FIG. 9 (and FIG. 10) illustrates how relative errors of an inverter (compared to other inverters) may evolve in time, here long-term, and herewith represents an example of underperformance graph per inverter in accordance with an embodiment of the invention.

A variant embodiment is for instance to consider relative errors according to zenith and azimuth. The purpose of the relative error with performance reference according to zenith and azimuth is to display the underperformance of inverters by taking into account the position of the sun. The objective is to detect possible underperformance due to external phenomenon such as shading. Again, the points are treated as provided in the dataset. A particular quantile, for example 0.8 of all inverters’ production is e.g. defined as the performance reference. For each inverter, the relative error, i.e. the difference between its production and the performance reference divided by this reference, is computed. The error with reference can be displayed according to the solar position (azimuth and zenith of the sun).

As a result, for example a 2D grid can be created wherein the values on the grid being computed by nearest neighbour interpolation of the relative errors. The outputs are e.g. graphs per inverter of the relative error in 2 dimensions in function of the azimuth and the zenith. According to another embodiment, instead of nearest neighbour interpolation, the technique of radius neighbours regressor could be applied instead herewith computing the median of all the points in certain zone of the graph, leading to more accurate and smoother results.

### E. Long-Term Degradation

The determination and visualization (graphical representation) of long-term degradation is now further considered, and an exemplary embodiment is given for the required calculations and computations.

In an embodiment, short-term performance deviation is filtered out in order not to disturb the analysis of long-term degradation. Hence, for having no impact on this analysis, a filter is applied that removes production data with too large short-term deviation. In other words, it filters out points with short-term performance deviation lower than a minimum acceptable. By default, this minimum acceptable is set to a particular value.

According to a mathematical model used, the following conditions are set, taking into account however that filtering, aggregation and regression method should stay flexible. For each inverter, for each year, only sunny months data production is retained: May, June, July and August. From this sub-dataset, a quantile of for example 0.7 of production is computed. Only productions larger than this quantile value are retained. The objective is to keep only instants with large production. A tuning of these filters may also be done according to datasets.

In an embodiment, the dataset is aggregated per day by mean function of the daily production. In order to compute the long-term degradation, a quantile regression is herewith performed. Again, as mentioned earlier, the advantage of quantile regression, relative to the ordinary least squares regression, is that quantile regression estimates are more robust against outliers in the response measurements. Further is recorded that for the graphical representation
the x-inputs are the days; and
the y-inputs are the power data divided by percentile 90 of the first year inverter power data.

The coefficient of the slope of quantile regression is considered as the long-term degradation coefficient. It is considered as a percentage of degradation per year (compared to the first year of operation). The confident intervals of the coefficient are also given. The Rsquare value allows to characterize the quality of regression: the larger is the Rsquare value, the more confident is quantile regression and so, the more confident is the long-term degradation coefficient. The long-term degradation coefficient may also be estimated using a non-linear regression or based on a year-to-year evaluation.

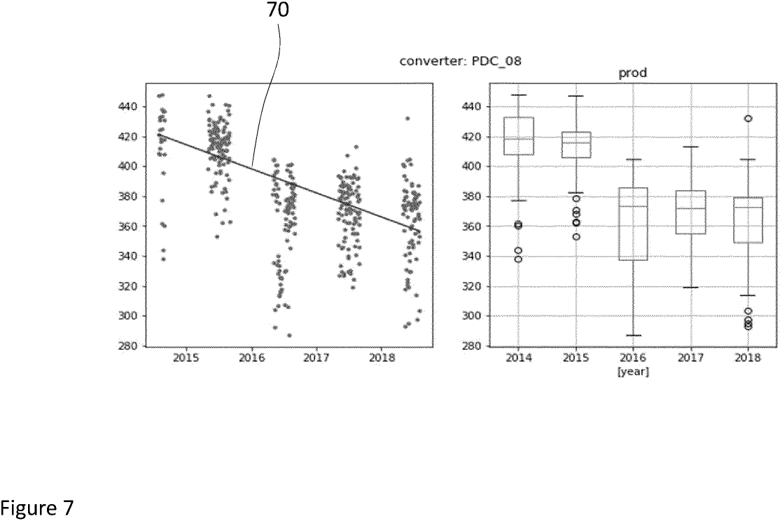

FIG. 7 illustrates an example of graph per inverter for the long-term degradation determination in accordance with an embodiment of the invention. For each inverter, a figure is generated with two subplots. The left plot, FIG. 7(a) represents the selected points and the line of quantile regression. The right plot, FIG. 7(b) is a box plot of the filtered productions data per year.

In a next step, a further embodiment comprising summary tables can be considered. Such summary tables are for example respective heatmap and long-term degradation coefficients table.

According to an embodiment, the heatmap table contains for each inverter, a percentile of e.g. 75 per year divided by the maximum of said percentile of e.g. 75 of all years. Herewith is allowed to have a percentage of degradation per year and to show the underperformance with respect to the reference year of each year.

According to an embodiment, the long-term degradation coefficients table contains for each inverter, the long-term degradation coefficients, the confident interval of the long-term degradation coefficients and the Rsquared values. The inverters are sorted by the Rsquared values. A variation from no degradation towards largest degradation for long-term degradation coefficients can be graphically represented.

### DETAILED DESCRIPTION OF THE EMBODIMENTS

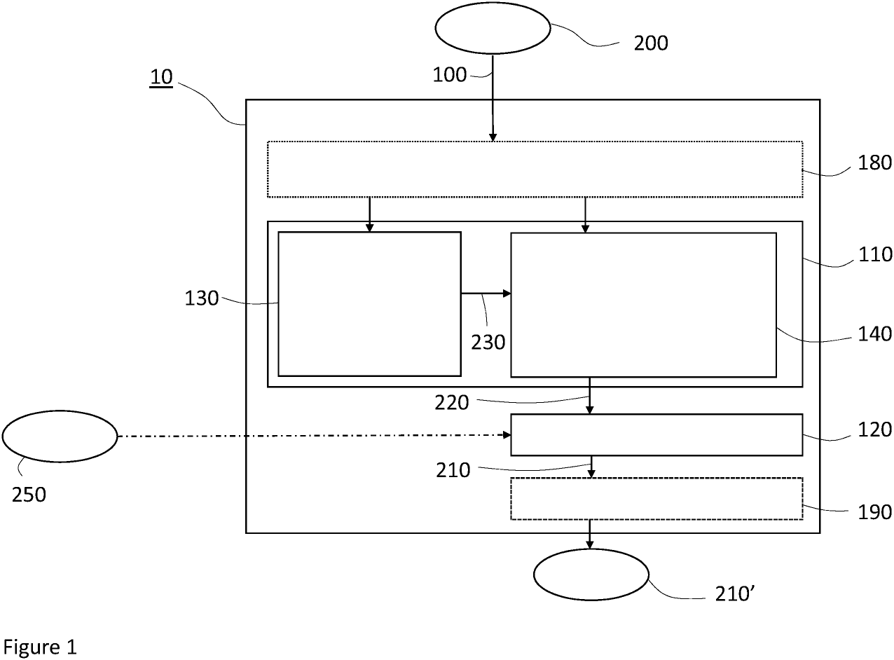

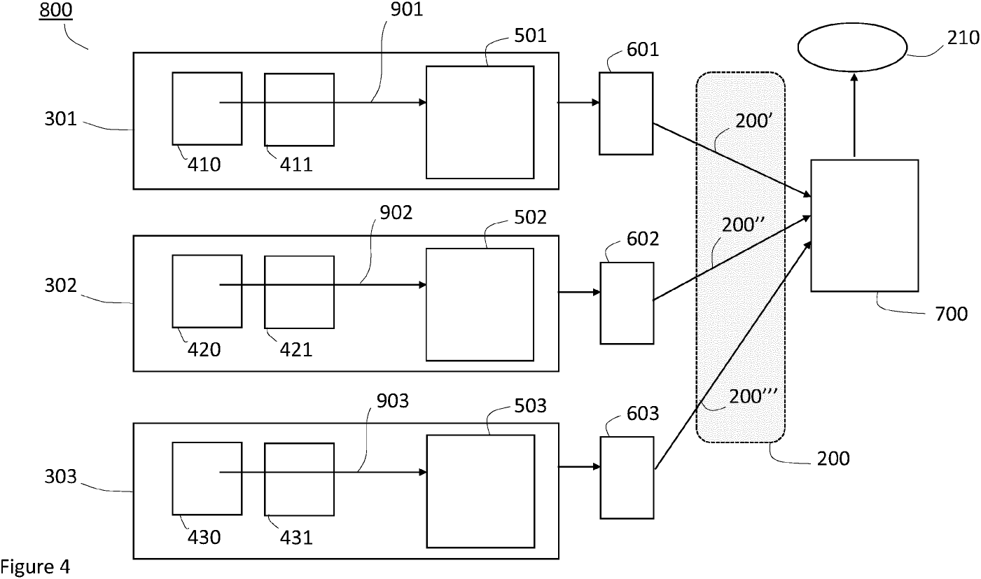

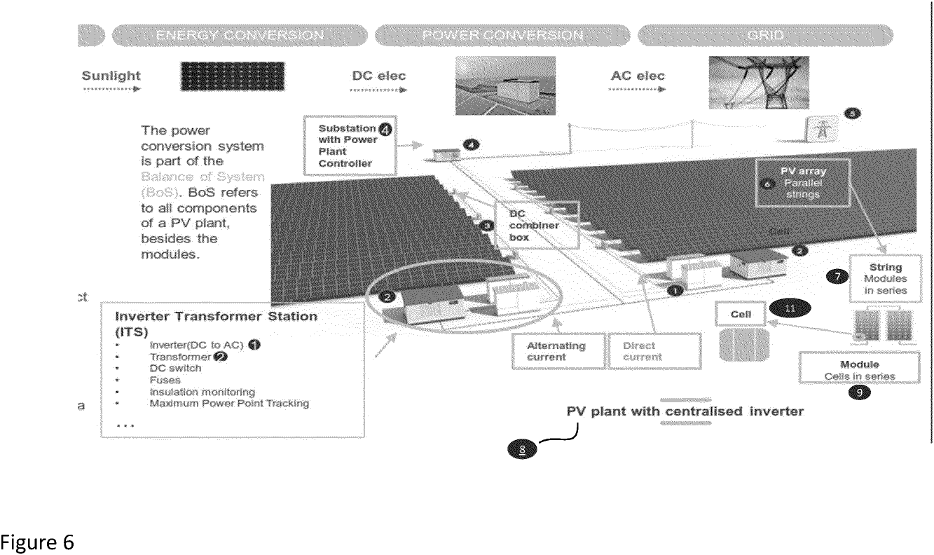

The present invention provides a method 10 for determining performance deviation 210 applied to a PV plant 800, 8. FIG. 1 illustrates an embodiment of the method 10 in accordance with the invention. FIG. 4 illustrates an embodiment of a PV plant 800 of a first topology, comprising of three PV configurations 301, 302, 303, each comprising of two PV modules 410, 411, 420, 421, 430, 431 and one inverter 501, 502, 503. The energy from sunlight as captured by the PV modules, after being converted into DC power, is transferred to the respective inverters 501, 502, 503, as indicated by the arrows 901, 902, 903, such that DC power can be converted into AC power. The output of each of the PV configurations 301, 302, 303 is transmitted to corresponding power generation measurement equipment 601, 602, 603 delivering respective power generated data 200′, 200″, 200‴. The combination of all respective power generated data 200′, 200″, 200‴ is determined as data 200, representative for the power generation. A computer environment 700 is connected to the power generation measurement equipment 601, 602, 603 and adapted to support execution of the method 10 for determining performance deviation 210 of one of the PV configurations 301, 302, 303, e.g. of PV configuration 301. As a result, the computer environment 700 determines the performance deviation 210, per each PV configuration, from the data 200, being representative for the power generation. An embodiment of a second topology for a PV plant 8 is illustrated in FIG. 6.

The method 10 as illustrated in FIG. 1 is initiated by providing or loading data 200, representative for the power generation, originating from a plurality of PV configurations, being for example three PV configurations 301, 302, 303 of which PV configuration 301 is part, while also considering FIG. 4. Within the PV plant 800 of FIG. 4, the PV configurations 301, 302, 303 can be considered substantially similar. Next, the loaded data 200 is normalized 110 to obtain normalized power generation data 220. Having the loaded data 200 normalized comprises of two steps. In a first step, first normalization information 230 is determined 130 from the loaded data 200, while in a second step this first normalization information 230 is used to normalize 140 the loaded data 200. The normalized power generation data 220 is then used for determining 120 the performance deviation 210 of the PV configuration 301. As depicted with dotted line in FIG. 1, prior to normalizing 110 the loaded data 200, a pre-processing step 180 can be applied onto this loaded data 200. The pre-processing step 180 can be for example selecting of non-zero data amongst the loaded data 200 e.g. to herewith remove unavailability. The pre-processing may also comprise filtering outliers e.g. by use of a median absolute deviation method or z-score, and/or selecting of (non-zero) (filtered for outliers) data exceeding a predetermined threshold. As depicted with dashed line in FIG. 1, after having determined 120 the performance deviation 210, a post-processing 190 can be applied onto this performance deviation 210, hence generating post-processed performance deviation 210′. The method 10 may also comprise further providing or loading of information 250 related to the sun position, either direct or indirectly such as PV plant position from which sun position can be calculated. The sun position information 250 can be taken into account (e.g. by taking into account shading effects) for determining 120 the performance deviation 210 of the PV configuration 301. It is particularly noted however, that the method 10 as described is excluding the use of irradiance measurements. When determining 120 the performance deviation 210 of the PV configuration 301 it may also be foreseen therewith, to have a step of computing a (relative) metric of performance of the PV configuration 301, in relation to the performance deviation 210 being determined, relative to a (computed) performance reference.

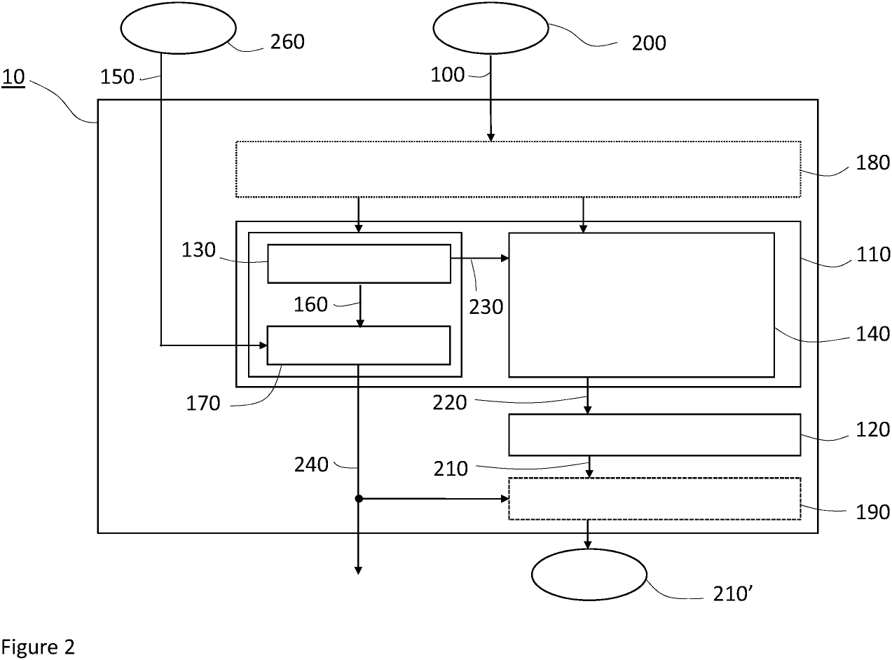

FIG. 2 illustrates a further version of the embodiment of FIG. 1 related to the method 10 for determining performance deviation 210 applied to a PV plant 800, 8 in accordance with the invention. The method 10 in FIG. 2 further comprises providing or loading 150 of nominal power 260 of the plurality of, here considered three as depicted in FIG. 4, PV configurations 301, 302, 303. The nominal power 260 can be used for determining 170 second normalization information 240, comprising the following two steps. Firstly, first normalization information 230 as determined 130 is retrieved 160, and secondly first normalization information 230 is corrected 170. Herewith obtained corrected first normalization data is determined as second normalization information 240, which can be further used for post-processing 190.

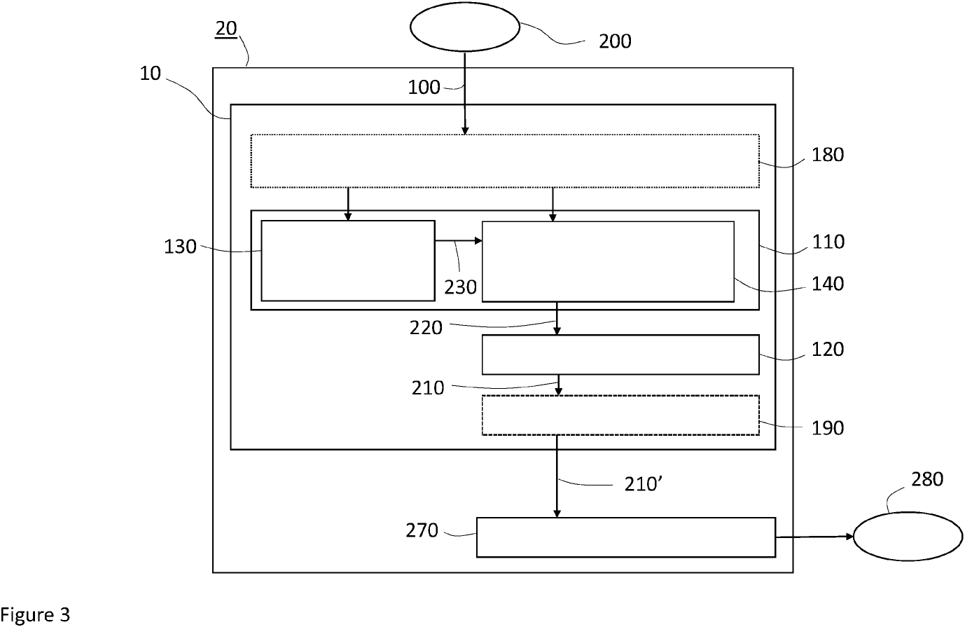

An embodiment of the method 20 for detecting underperformance 280 applied to a PV plant 800, 8 in accordance with the invention, is shown in FIG. 3. The method 20 for detecting underperformance comprises the method 10 for determining performance deviation 210 as depicted in FIG. 1, wherein is provided the step of computing a (relative) metric of performance of the PV configuration 301, in relation to the performance deviation 210 being determined, relative to a (computed) performance reference corresponding to a well performing virtual configuration. The method 20 further comprises additional step of comparing 270 the (relative) metric of performance of the PV configuration 301 with a threshold. By means of this comparison, the underperformance 280 and the location thereof can be determined. Prior to comparing 270, the (relative) metric of performance of the PV configuration 301 may be filtered e.g. as a post-processing step 190 for smoothening purposes.

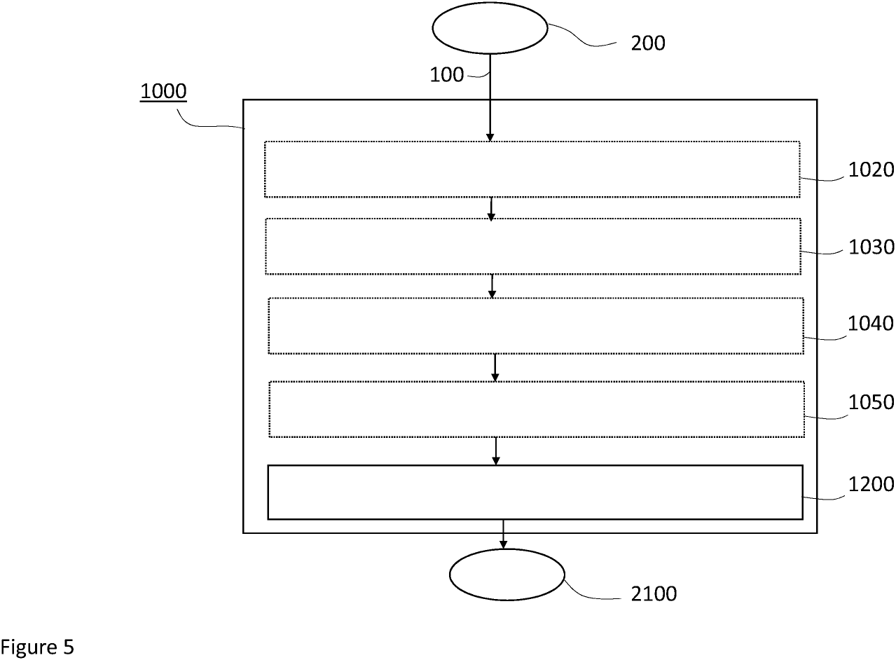

FIG. 5 illustrates an embodiment of the method 1000 for determining long-term degradation 2100 applied to a PV plant 800, 8 in accordance with the invention. According to embodiment, the method 1000 is particularly related to one single PV configuration. As illustrated in FIG. 5, the method 1000 is initiated by providing or loading data 200, representative for the power generation, originating from a PV configuration, being for example PV configuration 301, while also considering FIG. 4. Next, the long-term degradation 2100 of the PV configuration 301 is determined 1200 from determining a long-term trend therein. Prior to determining 1200 the long-term degradation 2100, a first pre-processing step 1020 may be applied onto the loaded data 200 for performing a selecting of the data 200 related to sunny production months. In addition, prior to determining 1200 the long-term degradation 2100, a second pre-processing step 1030 may be applied onto the loaded data 200 for performing a selecting of the data 200 exceeding a predetermined threshold. Further, prior to determining 1200 the long-term degradation 2100, a third pre-processing step 1040 may be applied onto the loaded data 200 for performing an outlier filtering. Moreover, prior to determining 1200 the long-term degradation 2100, a fourth pre-processing step 1050 may be applied onto the loaded data 200 for performing a (mean) aggregation over a predetermined period.

As yet mentioned above, an embodiment of a second topology for a PV plant 8 is illustrated in FIG. 6. Sunlight is captured by one or more PV arrays 6 and the energy collected herewith is converted to DC power. Per PV array, a DC combiner box 3 gathers all DC power to be transmitted to a centralized inverter, in particular towards the Inverter Transformer Station (ITS) where DC power is first inverted to AC power by means of an inverter 1 and then further transmitted towards a transformer 2. All AC power from the from the PV arrays, in particular from the respective transformers 2 thereof, is collected in the Substation with Power Plant Controller 4 from which it is then transmitted to the grid 5. As depicted in FIG. 6, a PV array 6 comprises a plurality of parallel PV strings 7, wherein each PV string 7 comprises a plurality of PV modules 9 in series, wherein each PV module 9 comprises a plurality of PV cells 11 in series.

FIG. 7 illustrates an example of two possible graphical plots visualizing the long-term degradation per inverter in accordance with the invention. FIG. 7(a) represents multiple clusters of points indicating the normalized and filtered production of the inverter. One cluster per year can be identified over a period of 5 years, being considered here as the long-term. Hence 5 clusters of points are depicted. The linear quantile regression representing the long-term degradation, evolving linearly, is clearly indicated by the straight downward slope 70. FIG. 7(b) is a box plot showing the normalized and filtered productions of the inverter per year, over the long-term period of 5 years.

FIG. 8 illustrates an example of quantile regression between inverters in accordance with the invention. Power data of one inverter (on y-axis) is shown versus the computed reference (P90 of all inverters power data on x-axis). It is noted that all inverters power data are divided by their respective (per inverter) median before the normalization step. Data points are representative of all operations conditions of the inverter over the historical period covered by the data set. Objective of the algorithm is to find the regression line passing through the cloud (even better the top of the cloud corresponding to the best performance) which is the most representative of normal operation (high density of points). In some case, several clouds are visible (e.g. due to operation in degraded mode for a long time) and a tuning can be done by filtering low power data points. The slope of the regression line means that the inverter power is 18% lower (in the example of FIG. 8) than the reference power based on historical data. The slope is then used in normalization process (the inverter power data is divided by the slope) such that all inverters can be compared.

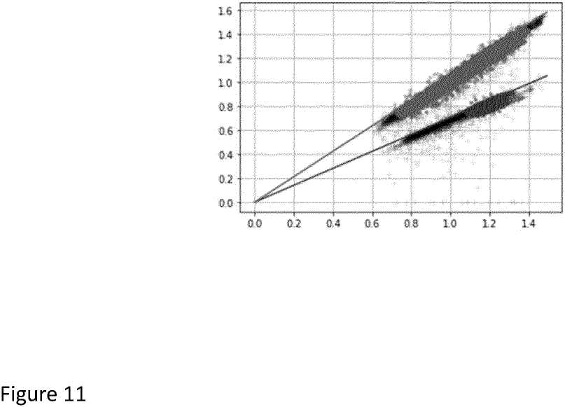

FIG. 11 illustrates another example of quantile regression between inverters in accordance with an embodiment of the invention. Power data of each inverter is first normalized by dividing by the median of all data of this inverter. A reference is then calculated corresponding to the percentile 95 of all inverters power data. And finally power data of one inverter (on y-axis) is shown versus the computed reference (on x-axis). Data points are representative of all operations conditions of the inverter over the historical period covered by the data set. Objective of the algorithm is to find the regression line passing through the cloud (even better the top of the cloud corresponding to the best performance) which is the most representative of normal operation (high density of points). In some cases, several clouds are visible (e.g. due to operation in degraded mode for a long time). A clustering algorithm (DBSCAN) can be used to detect the different clouds. The quantile regressions passing through the upper part of each cloud (q=0.9) as well as the range on x-axis covered by the cloud are computed. Several checks are then performed to verify the validity of the cloud:
The maximum value of the cloud on x-axis is above 0.6
The maximum value of the cloud on y-axis is above 0.6
The slope of the regression line lies between 0.9 and 1.2
The range covered by the cloud is equal of above the percentile 75 of all detected clouds Finally, among the valid clouds, the steepest slope is recorded.

The slope of the regression line means that the inverter power is 6% higher (in the example of FIG. 11) than the reference power based on historical data. The slope is then used in normalization process (the inverter power data, first normalized by the median, is divided by the slope) such that all inverters can be compared.

After normalization of power data using the method described above, inverters can be compared to detect underperformances. It is done by calculating for each timestamp a virtual reference corresponding to a well performing inverter. This reference is obtained by taking the percentile 80 of all inverters power for this time stamp. Computing this virtual reference for each timestamp allows to always compare with a virtual inverter showing good performance.

FIG. 9 illustrates an example of underperformance graph per inverter in accordance with the invention. On the x-axis, the years 2014 till 2019 are given in order to display the evolution in time, being a long-term period of 5 years, whereas on the y-axis the relative error with reference is plotted being an indication for the underperformance whenever this relative error turns out too big (here negative value). Upper threshold 81 and lower threshold 82 of the smoothened error are represented. Below this smoothened error, i.e. below the lower threshold 82, the inverter underperforms significantly compared to other inverters. As can be seen in FIG. 9, the relative error curve 80 comes below the lower threshold 82 in 2016, and hence the inverter starts underperforming in 2016. The underperformance partially seems to recover for some time in 2016, but then further increases and becomes definite in 2017. It is further mentioned that the curve is the result of a moving average or median calculation (smoothening) and that the corresponding window can be adapted. In the example, several years are shown with a moving average of e.g. 3 months but investigation can be performed for the last 3 months with a moving average of 1 week (more punctual issues may become visible).

FIG. 10 shows another example of underperformance graph per inverter in accordance with the invention, with moving average on 1 month.

1. A method (10) for determining performance deviation (210) of a PV configuration (301) from data (200), representative for the power generation, from a plurality of PV configurations (301, 302, 303) without the use of irradiance measurements, the method comprising the steps of: (i) providing (100) said data (200), representative for the power generation, from said plurality of PV configurations; (ii) normalizing (110) said data (200) to obtain normalized power generation data (220) for comparing of PV configurations; and (iii) determining (120) said performance deviation (210) of said PV configuration (301) from said normalized power generation data (220) by comparing PV configurations.

2. The method of claim 1, wherein said step of normalizing (110) comprising the steps of: (a) determining (130) first normalization information (230) from said data (200), representative for the power generation; and (b) normalizing (140) said data (200) by use of said first normalization information (230).

3. The method of claim 2, wherein said step of determining (130) said first normalization information (230) comprises determining a relationship between said data (200), representative for the power generation, from a plurality of PV configurations, preferably before said first normalization information (230) is determined, said data (200), representative for the power generation, is for each of said PV configuration divided by its average or median value or nominal value.

4. The method of claim 3, wherein said step of determining a relationship being based on regression.

5. The method of claim 3 or 4, wherein said step of determining a relationship being performed either (a) for each inverter relative to a normalization reference, preferably said normalization reference being computed from power generation data (220) from the plurality of PV configurations or (b) pair-wise between inverters, preferably prior to said determining a relationship a (data cloud) clustering is performed, relationships per cloud are determined and said relationship is selected therefrom.

6. The method of claim 2 to 5, further comprising: (c) providing (150) of nominal power (250) of said plurality of PV configurations; and (d) use of this nominal power (250) for determining (170) second normalization information (240).

7. The method of claim 6, wherein said use of this nominal power (250) comprising the steps of: (e) retrieving (160) said first normalization information (230) as determined in step (a); and (f) correcting (170) said first normalization information (230) to obtain corrected first normalization data herewith determining said second normalization information (240).

8. The method of any of the previous claims, wherein said step (iii) comprising the step of computing a metric of performance of said PV configuration (301), in relation to said performance deviation (210) being determined, relative to a performance reference, preferably said reference being computed from said normalized power generation data (220), preferably after said second normalization (240), from the plurality of PV configurations.

9. The method of any of the previous claims, further providing or loading information (250) related to the sun position, and taking into account said sun position information (250) for said determining (120) of said performance deviation (210) of said PV configuration (301) in step (iii).

10. The method of any of the previous claims, wherein prior to said step (ii) of normalizing (110) said data (200), a pre-processing step (180) is applied onto said data (200) as being provided in step (i), and wherein said pre-processing step performing one or more of the following: selecting of non-zero data amongst said data (200), filtering outliers and selecting of data exceeding a predetermined threshold.

11. A method (20) for detecting underperformance (280) of a PV configuration (301) from data (200), representative for the power generation, from a plurality of PV configurations without the use of irradiance measurements, the method comprising the method of claim 8, and further comprising additional step (iv) comparing (270) said metric of performance of said PV configuration (301) with a threshold, by means of which said underperformance is detected.

12. The method of claim 11, wherein prior to said step (iv) of comparing (270), said metric of performance of said PV configuration (301) is filtered for smoothening purposes.

13. A computer program product comprising computer-readable code, that when run on a computer environment supports execution of any of the methods of claim 1 to 12.

14. A database, adapted to run on a computer environment, comprising data (200) from a plurality of PV configurations and suitably arranged for use by any of the methods of claim 1 to 12.

15. A PV plant (800), comprising: a plurality of PV configurations (301, 302, 303); a plurality of power generation measurement equipment (601, 602, 603), one for each PV configuration; and a computer environment (700), connected to said plurality of power generation measurement equipment and adapted to support execution of any of the methods of claim 1 to 12.

16. A method (1000) for determining long-term degradation (2100) of a PV configuration (301) from data (200), representative for the power generation of said PV configuration (301) without the use of irradiance measurements, the method comprising the steps of: (i) providing (100) said data (200); and (ii) determining (1200) said long-term degradation of said PV configuration (301) from determining a long-term trend therein.

17. The method of claim 16, wherein said step of determining (1200) being based on regression.

18. The method of claim 16 or 17, wherein prior to said step (ii) of determining (1200), a first pre-processing step (1020) is applied onto said data (200) as being provided in step (i), and wherein said first pre-processing step (1020) performing a selecting of said data (200) related to sunny production months.

19. The method of claim 16 to 18 wherein prior to said step (ii) of determining (1200), a second pre-processing step (1030) is applied onto said data (200) as being provided in step (i), and wherein said second pre-processing step (1030) performing a selecting of said data (200) exceeding a predetermined threshold.

20. The method of claim 16 to 19 wherein prior to said step (ii) of determining (1200), a third pre-processing step (1040) is applied onto said data (200) as being provided in step (i), and wherein said third pre-processing step (1040) performing an outlier filtering.

21. The method of claim 18 to 20, wherein prior to applying any of said first, second or third pre-processing step, an initial filtering is performed, based on underperformance as determined by any of the methods of claim 11 or 12.

22. The method of claim 16 to 21 wherein prior to said step (ii) of determining (1200), a fourth pre-processing step (1050) is applied onto said data (200) as being provided in step (i), and wherein said fourth pre-processing step (1050) performing a aggregation over a predetermined period.

23. A computer program product comprising computer-readable code, that when run on a computer environment supports execution of any of the methods of claim 16 to 22.

24. A database, adapted to run on a computer environment, comprising data (200) from a plurality of PV configurations and suitable for use by any of the methods of claim 16 to 22.

25. A PV plant (800), comprising: a plurality of PV configurations (301, 302, 303); a plurality of power generation measurement equipment (601, 602, 603), one for each PV configuration; and a computer environment (700), connected to said plurality of power generation measurement equipment and adapted to support execution of any of the methods of claim 16 to 22.
